(19) United States
(12) Patent Application Publication
(10) Pub. No.: US 2014/0239241 A1
(43) Pub. Date: Aug. 28, 2014

(54) SYNTHESIS OF OIL-SOLUBLE NEW COMPOSITIONS USED FOR DSERSING PIGMENT NANOPARTICLES AND THEIR APPLCATION ON ELECTROWETTING DISPLAY

(71) Applicant: National Taiwan University, Taipei (TW)

(72) Inventors: Jiang-Jen Lin, Taipei (TW); Chih-Wei Chiu, Taipei (TW); Tzu-Chien Lee, Taipei (TW); Ling-Yu Chang, Taipei (TW)

(73) Assignee: National Taiwan University, Taipei (TW)

(21) Appl. No.: 14/147,137

(22) Filed: Jan. 3, 2014

(30) Foreign Application Priority Data
Feb. 25, 2013 (TW) 102106610

(51) Int. Cl. C09B 67/20

(52) U.S. Cl. CPC C09B 67/0069
USPC 252/586; 562/564; 548/546; 562/574; 562/565; 548/520

(57) ABSTRACT

The present invention provides a macromolecular dispersant and a synthesis method thereof, and the dispersant is synthesized by reacting polyisobutylene-g-succinic anhydride with amine compounds. In addition, the present invention also provides an oil-soluble dispersant composition with nano particle pigments and the manufacturing method thereof. The oil-soluble dispersant composition is manufactured by milling a macromolecular dispersant with a pigment and a grinding media. The oil-soluble dispersant composition is adequate for various pigments, shows the excellent immiscibility of oil/water interface, and owns the low viscosity of ≦4 cps and the optical density of ink ≧1.1. Therefore, the oil-soluble dispersant of the present invention for the nano particle pigment can be acted as the material of the electrowetting display.

### CROSS REFERENCE TO RELATED APPLICATIONS

The application claims the benefit of R.O.C. Patent Application No. 102106610, filed on Feb. 25, 2013, in the Intellectual Property Office of Republic of China, the disclosures of which is incorporated by reference as if fully set forth herein.

### BACKGROUND

1. Field of the Invention

The present invention relates to an oil-soluble composition and the synthesis method thereof. More particularly, it relates to an oil-soluble dispersant composition for dispersing nano-pigment particles, the manufacturing method thereof and its application of the electrowetting display.

2. Description of the Related Art

The electrowetting display employs the electrowetting effect, which is to modify the wetting property of hydrophilicity and hydrophobicity between materials with potential, to control the contact angle between the colored hydrophobic oil-medium and the hydrophobic dielectric layer. With the change of surface tension among the colored hydrophobic oil-medium, the conductive polar liquid and the hydrophobic dielectric layer, the purpose of transferring colors is accomplished. And the display having the reflection coefficient more than 35% and the contrast more than 15 is able to be manufactured with the technique thereof. The electrowetting display has the advantages of low power-consuming, short response time, needless backlight, no displaying differences along with various viewing angles, etc. And it is effective to display the animation. The densities of the hydrophobic oil-medium and the conductive polar liquid of the electrowetting display would be changed with temperature resulting in that the displaying quality is influenced and the life span of the electrowetting display is shorten.

Liquavista Corporation proposed the electrowetting display of single layer or dual layer structure. The electrowetting display of single layer is made of black ink and color filter. However, there is no black ink with pure color, high oil-solubility, high molar extinction coefficient, low viscosity and short response time, and furthermore the color filter significantly decreases the light utilization. Thus, it is not suitable for the reflection type electrowetting display. The multi-layer structure electrowetting display is made of stacks of electrowetting structures of blue, magenta and yellow. Thus, its light utilization is higher, its color gamut is narrower and it lacks for gray scale. Therefore, R.O.C. Patent Publication No. 201215645 discloses a dis-azo compound, a black ink, for overcoming the disadvantages of the black ink of Liquavista Corporation. But the black ink only adapts for the single layer electrowetting display with the color filter, and it is incapable of wider application.

Nowadays, the pigments for electrowetting displays usually have the high solubility, the high light tolerance, and the high durability, e.g. WO2010/031860 discloses the usage of the anthraquinone dye for electrowetting displays. Resulting from the low molar extinction coefficient of the anthraquinone dye, its concentration has to be higher to make the solubility of the anthraquinone dye be higher for showing the same absorbance as the heterocyclicazo dye. But the high concentration of the anthraquinone dye causes the variations of the electrowetting properties and the electronic properties. Therefore, the application of the anthraquinone dye to electrowetting displays is difficult. US2010/0292450A1 discloses a pyrazole disazo dye having high solubility in non-polar solvents. However, the color of the N-decane solution of the pyrazole disazo dye is yellow which is not capable of corresponding to the other colors.

Besides, the chromogenic material for the traditional electrowetting display technology is the oil-soluble dye. But its light tolerance and color saturation are poor. And it has to be processed with complicated purification procedures before using. Although, the dye has been replaced of the pigment or the carbon black to have the high light tolerance and the high color contrast currently, the dispersing stabilities of the pigment and the carbon black are not enough. The chromogenic material, e.g. pigments and carbon black, needs to be ground or stabilizer to achieve the nano-scale. Based on the aforementioned reasons, it is important to develop novel materials to stabilize the pigments or the carbon black and achieve the nano-scale thereof, wherein the novel materials have the better light tolerance, color contrast and dispersing stability.

### SUMMARY

In order to overcome the shortcomings of the prior arts, the present invention provides a novel oil-soluble composition, also known as a macromolecule dispersant, which disperses the pigments in nano-scale homogeneously and keeps high stability within organic solvents. In the present invention, the pigment particles are dispersed with the macromolecule dispersant to form a nano-pigment dispersant composition with the advantages of the none-oil-water emulsion, the low ink viscosity and the good optic properties, etc.

The present invention discloses a dispersant including a compound represented by formula I or II.

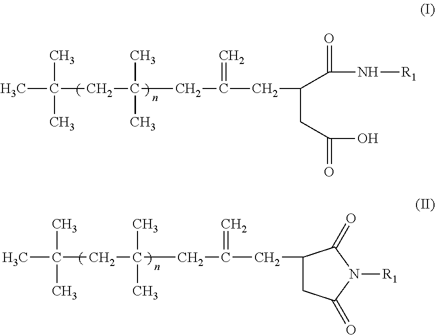

Wherein the R₁ is a mono-substituent which can be derived from amine compounds including but not limited to the first compounds (Cₐ H₂ₐ₊₁NH₂ with 6≦a≦18), the second compounds represented by formula III,

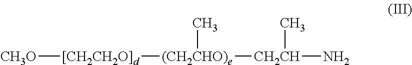

the third compounds represented by formula IV,

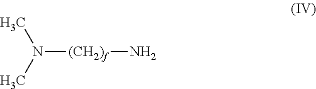

a diethanolamine (HO(CH₂)₂NH₂) an aminoethylethanolamine HO(CH₂)₂NH(CH₂)₂OH), a N-hydroxyethyl ethylenediamine (HO(CH₂)₂NH(CH₂)₂NH₂) and an ethylenediamine (NH₂(CH₂)₂NH₂).

Wherein the compounds represented by formula I or II are synthesized from polyisobutylene-g-succinic anhydride and the amine compound having the R₁ group, and the n value of polyisobutylene-g-succinic anhydride could be but not limited to 8, 9, 12, 13, 20 or 21. When n is 8 or 9, the molecular weight of polyisobutylene-g-succinic anhydride approximates 700; when n is 12 or 13, the molecular weight of polyisobutylene-g-succinic anhydride approximates 950; and when n is 20 or 21, the molecular weight of polyisobutylene-g-succinic anhydride approximates 1335.

The first compounds are the compounds of the alkylamines (CₐH₂ₐ₊₁NH₂, 6≦a≦18). In certain embodiments, the carbon numbers (a value) of the alkylamine are 6, 9, 10, 11, 12, 13, 14, 16 or 18. The alkyl group thereof may be linear or branching alkyl.

The second compounds (formula III) are the mono-amine compounds, Jeffamine®, marketed by Huntsman Corporation. The second compounds (formula III) include but not limited to POP-M600 (d=1, e=9, MW=600), POP-M1000 (d=3, e=19, MW=1000), POP-M2005 (d=29, e=6, MW=2000) and POP-M2070 (d=1, e=9, MW=2000).

The third compounds (formula IV) have arbitrary integral numbers of the carbon atom (f value) between 3 and 280. And the molecular weights of the third compounds are between 102 and 4000. In some examples, the third compound is the N,N-Dimethylaminopropylamine.

In addition, the aforementioned values of a, b, d, e, f and n are integrals.

The present invention discloses another dispersant including a compound represented by formula V or VI:

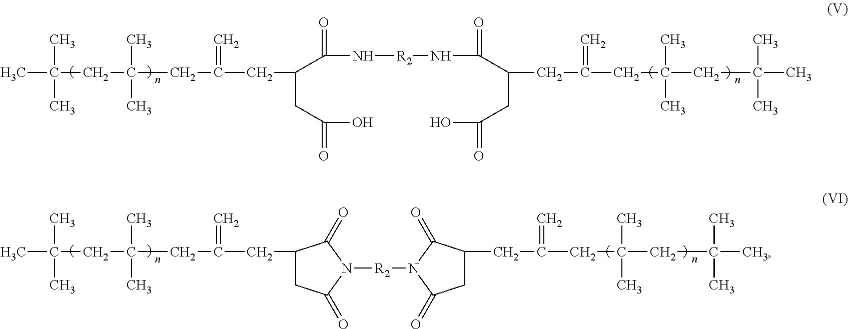

wherein the R₂ is a bi-substituent which can be derived from amine compounds including but not limited to the forth compounds (H₂N—(CH₂CH₂NH)ₐ—CH₂CH₂NH₂, 0≦a≦4), the fifth compounds (H₂N(CH₂)_{b}NH₂, 2≦b≦12), the sixth compounds represented by formula VII

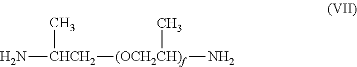

and a N-hydroxyethyl ethylenediamine(HO(CH₂)₂NH(CH₂)₂NH₂).

Wherein the compounds represented by formula V and VI comprise two polyisobutylene-g-succinic anhydrides and an amine compound with a R₂ group. As the same as aforementioned, the n value of polyisobutylene-g-succinic anhydride could be but not limited to 8, 9, 12, 13, 20 or 21. When n is 8 or 9, the molecular weight of polyisobutylene-g-succinic anhydride approximates 700; when n is 12 or 13, the molecular weight of polyisobutylene-g-succinic anhydride approximates 950; and when n is 20 or 21, the molecular weight of polyisobutylene-g-succinic anhydride approximates 1335.

The sixth compounds (formula VI) are the bi-amine compounds, Jeffamine®, marketed by Huntsman Corporation. The sixth compounds (formula VI) include but not limited to POP-D230 (f=2˜3, MW=230), POP-D400 (f=5˜6, MW=400), POP-D2000 (f=33, MW=2000) and POP-D4000 (f=68, MW=4000). However, the person having ordinary skill in the art may make f value of the sixth compound between 2 and 68 to carry out the present invention. In addition, the aforementioned values of a, b, f and n are integrals.

The present invention discloses another dispersant including a compound represented by formula VIII or IX:

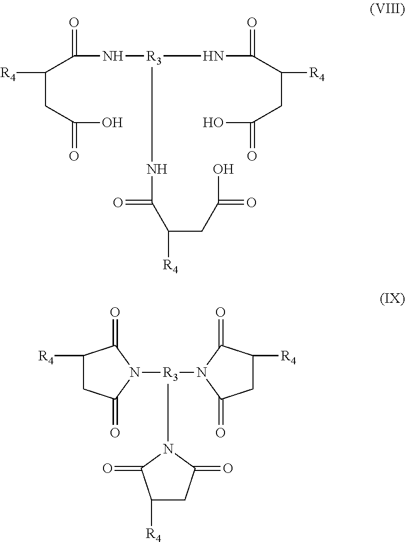

wherein the R₃ is a tri-substituent which can be derived from amine compounds including but not limited to the seventh compound (H₂N—(CH₂CH₂NH)ₐ—CH₂CH₂NH₂, 1≦a≦4) and the eighth compounds represented by formula X,

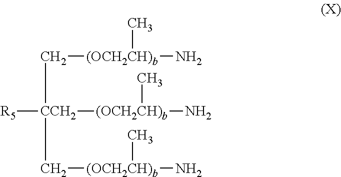

wherein the R₄ is a substituent represented by formula XI

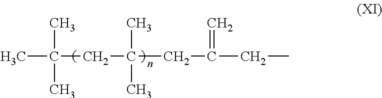

Wherein, the compounds represented by formula VIII and IX comprise three molecules of polyisobutylene-g-succinic anhydride and an amine compound with the R₃. The R₄ substitutent (formula XI) is the polyisobutylene group of the polyisobutylene-g-succinic anhydride and n value of the polyisobutylene group includes but not limited to 8, 9, 12, 13, 20 or 21. When n is 8 or 9, the molecular weight of the polyisobutylene-g-succinic anhydride approximates 700; when n is 12 or 13, the molecular weight of the polyisobutylene-g-succinic anhydride approximates 950; and when n is 20 or 21, the molecular weight of the polyisobutylene-g-succinic anhydride approximates 1335.

Besides, the eighth compounds (formula X) are the tri-amine compounds of Jeffamine® marketed by Huntsman Corporation. The eighth compounds (formula X) include and not be limited to POP-T403 (the R₅ is an ethyl group (—C₂H₅), f=2˜3, MW=400), POP-T3000 (the R₅ is a hydrogen group (—H), f=5˜6, MW=3000) and POP-T5000 (the R₅ is a hydrogen group (—H), f=33, MW=5000). However, the person having ordinary skill in the art could understand that the R₅ could be other substituent beyond ethyl group and hydrogen group, for example methyl group, propyl group, hydroxyl group, etc. And the f value may be a positive integrals lying in between 2 and 68. And the eighth compounds can be obtained from the combination of the different R₅ and f values to apply to the present invention. Furthermore, a, b and n are integral.

The present invention also provides a method for preparing the dispersant comprising causing a polyisobutylene-g-succinic anhydride to react with an alkylamine to obtain the dispersant.

According to above-mentioned concept, a polyisobutylene-g-succinic anhydride and an alkylamine are solved in an organic solvent respectively and then they are mixed together. The reaction is caused under 0˜180° C. for 1˜10 hours. In certain embodiments, the organic solvent is an oiliness organic solvent. The categories of the organic solvents comprise and not being limited to decane, dodecane, toluene and xylene.

In certain embodiments, when the amine compound includes one amine group, the molar ratio of the polyisobutylene-g-succinic anhydride to the alkylamine is between 2:1 and 1:2, for example 1:1, etc. In certain embodiments, when the amine compound includes two amine groups, the molar ratio of the polyisobutylene-g-succinic anhydride to the alkyl amine is between 4:1 and 1:4, for example 2:1, etc. In certain embodiments, when the amine compound includes three amine groups, the molar ratio of the polyisobutylene-g-succinic anhydride to the alkylamine is between 6:1 and 1:6, for example 3:1, etc.

The present invention also provides a dispersant composition comprises a pigment and a dispersant including the compounds of the formula I, II, V, XI, VIII or IX.

The weight ratio of the dispersant to the pigment can be arbitrary. For example, dispersant: pigment is 1:1˜99 or 1˜99:1. Resulting from the dispersant and the pigment are dissolved with the organic solvent, the weight ratio of the dispersant to the pigment to the organic solvent can be 1:1:1˜99, 1:1˜99:1, 1˜99:1:1, or 1˜99:1˜99:1˜99.

Said dispersant composition further comprises the grind medium for grinding said dispersant and pigment. In certain embodiments, the grind medium is but not limited to the Zirconium beads.

The present invention also provides a method for preparing the dispersant composition comprising causing a polyisobutylene-g-succinic anhydride to react with an alkylamine, so as to obtain the dispersant; and grinding the dispersant and the pigment along with the grinding medium, so as to obtain the dispersant composition.

The pigments of the present invention include but not limited to organic and inorganic pigments. The organic pigments include but not limited to red, orange, yellow, green, blue, purple, brown, black and white of Color Index. The inorganic pigments include but not limited to the pigments of carbon black and titanium dioxide white.

The red pigments comprise the red pigments of 2, 3, 4, 5, 8, 9, 12, 13, 17, 21, 22, 23, 31, 32, 38, 48:1, 48:2, 48:3, 48:4, 49:1, 49:2, 52:1, 52:2, 53:1, 53:3, 57:1, 60, 63:1, 81, 81:1, 81:2, 81:3, 83, 104, 112, 122, 123, 144, 146, 147, 149, 150, 151, 166, 166, 169, 170, 171, 172, 173, 175, 176, 177, 179, 181, 184, 185, 185, 188, 190, 195, 202, 208, 210, 224, 242, 243, 245, 254, 255, 264, 266, 268, 269 and 273.

The orange pigments comprise the orange pigments of 5, 13, 16, 31, 34, 36, 38, 40, 42, 43, 51, 55, 59, 61, 62, 64, 65, 71 and 73.

The yellow pigments comprise the yellow pigments of 1, 3, 5, 12, 13, 14, 15, 16, 17, 20, 24, 31, 34, 53, 55, 62, 63, 65, 73, 74, 75, 81, 83, 86, 93, 94, 97, 98, 100, 104, 109, 110, 117, 125, 126, 127, 128, 137, 138, 139, 147, 148, 150, 151, 153, 154, 155, 166, 168, 173, 174, 175, 176, 180, 181, 183, 184, 185, 188, 191, 192, 194 and 270.

The green pigments comprise the green pigments of 7, 8, 18, 36, 38 and 41.

The blue pigments comprise the blue pigments of 1, 10, 14, 15, 15:2, 15:6, 17:1, 27, 29, 56, 60, 61, 62, 63 and 78.

The purple pigments comprise the purple pigments of 1, 2, 2:2, 3, 3:1, 3:4, 19, 23, 27, 29, 32, 36 and 38.

The brown pigments comprise the brown pigments of 6, 23 and 25.

The black pigments comprise the black pigments of 1 and 7.

The white pigments comprise the white pigments of 6 and 24.

The black inorganic pigments comprise a carbon black, a titanium black, a titanate nitride, a low-valence titanium oxide, a graphite powder, a ferric oxide black, a copper oxide. In certain embodiments, carbon black is the better choice in aspect of the light sensitivity, the resolution and the adhesion.

Wherein, the carbon black comprises the carbon black #4000, #4010, #3950, #3750, #3250, #3150, #3050, #2400, #2350, #2300, #2200, #1000, #980, #970, #960, #950, #900, #850, #650, #55, #52, #50, #47, #45, #44, #40, #33, #32, #30, #20, #10, #5, MA7, MA8, MA11, MA14, MA100, MA220, MA230, MA600, MCF88, IL7B, IL11B, 1L30B, IL31B, 1L52B, CF9 and diamond black (diamond A, N220M, N234, I, LI, 11, N339, SH, SHA, LH, H, HA, SF, N550M, E, G, R, N760M and LP) manufactured by Mitsubishi Chemical Corp. Other than the carbon black manufactured by Mitsubishi Chemical Corp. the person having ordinary skill in the art would be familiar with the carbon black manufactured by Asahi Carbon Co., Ltd., Cancarb Ltd., Degussa AG, Cabot Corp. and Colombian Chemicals.

The white pigments comprise a kaolinite, a dolomite, a titanium oxide.

### DETAILED DESCRIPTION

The present invention will now be described more specifically with reference to the following embodiments. It is to be noted that the following descriptions of preferred embodiments of this invention are presented herein for the aspect of illustration and description only; it is not intended to be exhaustive or to be limited to the precise from disclosed.

The present invention discloses a novel oil soluble composition and the method for producing thereof. The method is causing a polyisobutylene-g-succinic anhydride (PIB-SA) to react with an alkyl amine, so as to obtain the dispersant. The dispersant such as the product as represented by formula I or II is obtained from the amine compound with one amine group reacting with the PIB-SA; or the dispersant such as the product as represented by formula V or VI is obtained from the amine compound with two amine groups reacting with the PIB-SA; or the dispersant such as the product as represented by formula VIII or IX is obtained from the amine compound with three amine groups reacting with the PIB-SA.

Therefore, the first type PIB macromolecule dispersant is obtained through conjugating a mono-amine group (R₁, R—NH₂) with the end of PIB-SA. The general formula is R—R₁, wherein the R is a PIB-SA. The second type PIB macromolecule dispersant is obtained through conjugating a bi-amine group (R₂, H₂N—R—NH₂) with the ends of PIB-SAs. The general formula is R′—R₂, wherein the R′ is two PIB-SAs. The third type PIB macromolecule dispersant is obtained through conjugating a tri-amine group with the ends of PIB-SAs. The general formula is R″—R₃, wherein the R″ is three PIB-SAs.

The obtained macromolecule dispersant may have the structure of amide or amide-amide. For example, when a polyamine is used (e.g. Diethylenetriamine, EDTA, EDTA:PIB-SA=2:1), amine groups exist in the macromolecule dispersant and the electrowetting effect could be further adjusted by adding the acidic ingredient (e.g. acetic acid or p-toluenesulfonic acid (PTSA)). In certain embodiments and the following structures, when n=0, the macromolecule dispersant is represented by PIB-amide-PIB; when n=1, 2, 3, 4 or other integrals, the macromolecule dispersant is represented by PIB-amide-amine-amide-PIB.

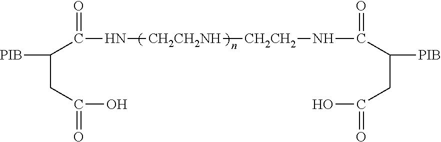

Or in certain embodiments and the following structures, when n=0, the macromolecule dispersant is represented by PIB-imide-PIB; when n=1, 2, 3, 4 or other integrals, the macromolecule dispersant is represented by PIB-imide-amine-imide-PIB.

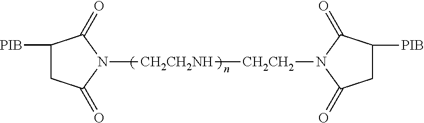

When the ethylenediamine (EDA) is used for the reaction, under the condition of the molar ratio of EDA:PIB-SA equals 1:1, it allows that an amide group and an amino group bonding to the end of the PIB, as the following structure (PIB-amide-amine).

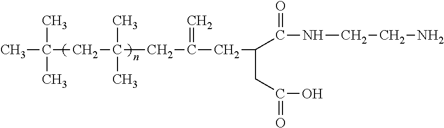 [SMILES: C=C(CC(CC(=O)O)C(=O)NCCN)CC(C)(C)CC(C)(C)C]

Or it allows that an imide group and an amino group bonding to the end of the PIB, as the following structure (PIB-amide-amine)

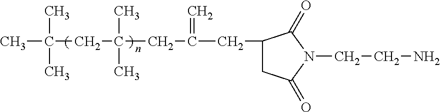 [SMILES: C=C(CC1CC(=O)N(CCN)C1=O)CC(C)(C)CC(C)(C)C]

The present invention provides a nano pigment particle oiliness dispersant composition made of said macromolecule dispersant and the method for preparing thereof. The method for preparing dispersant composition includes grinding said macromolecule dispersant and the pigment along with the grinding medium, so as to obtain the dispersant composition.

Embodiments 1˜6 give the examples of the method for preparing macromolecule dispersant.

In embodiment 1, reacting PIB-SA and C₁₂H₂₅NH₂ under the ration of 1:1. First, solving PIB-SA (9.5 g, MW=950) by decane (9.5 g) in a flask and stirring with magnetite. And then, adding C₁₂H₂₅NH₂ (1.85 g) into decane (39.2 g) in a 100 ml glass bottle and shocking for desolving with a shocker. Slowly droping the mixture of C₁₂H₂₅NH₂ and decane into the mixture of PIB-SA and decane and then reacting in 25° C. for 3 hours. Measuring the reaction by IR spectrometer and sampling after periods till the peak of anhydride functional group shown by FT-IR spectrum disappears and the amide groups are formed and the amide groups doesn't increase any more. The product of fully reacting is brown viscous liquid which is the dispersant of the present invention and it is abbreviated as PIB-amidoacid-C12.

In embodiment 2, reacting PIB-SA and C₁₄H₂₉NH₂ under the ration of 1:1: the method for preparing, sampling and measuring are the same as above-mentioned embodiment 1. The PIB-SA (9.5 g, MW=950) solved in decane (9.5 g) and C₁₄H₂₉NH₂ (2.13 g) solved in decane (17.57 g) are the reactants. The reaction time is 3 hours under 25° C. The product of fully reacting is brown viscous liquid which is the dispersant of the present invention and it is abbreviated as PIB-amidoacid-C14.

In embodiment 3, reacting PIB-SA and C₁₈H₃₇NH₂ under the ration of 1:1: the method for preparing, sampling and measuring are the same as above-mentioned embodiment 1. The PIB-SA (9.5 g, MW=950) solved in decane (9.5 g) and C₁₈H₃₇NH₂ (2.69 g) solved in decane (39.2 g) are the reactants. The reaction time is 3 hours under 25° C. The product of fully reacting is brown viscous liquid which is the dispersant of the present invention and it is abbreviated as PIB-amidoacid-C18.

Embodiments 1˜3 could be illustrated by the following reaction I:

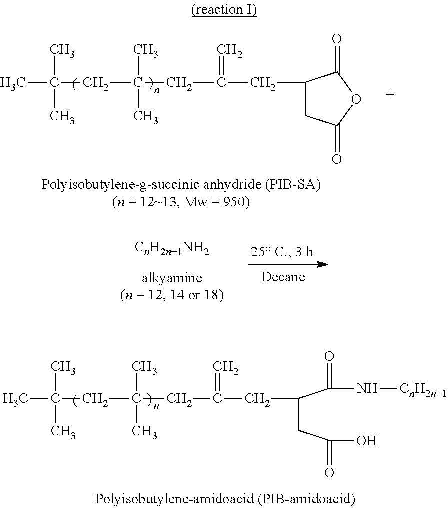

In embodiment 4, reacting PIB-SA and C₁₈H₃₇NH₂ under the ration of 1:1: the method for preparing, sampling and measuring are the similar with the above-mentioned embodiment 1. The PIB-SA (9.5 g, MW=950) solved in decane (9.5 g) and C₁₈H₃₇NH₂ (2.69 g) solved in decane (39.2 g) are the reactants. The reaction time is 3 hours under 150° C. The product of fully reacting is brown viscous liquid which is the dispersant of the present invention and it is abbreviated as PIB-imide-C18.

Embodiment 4 could be illustrated by the following reaction II:

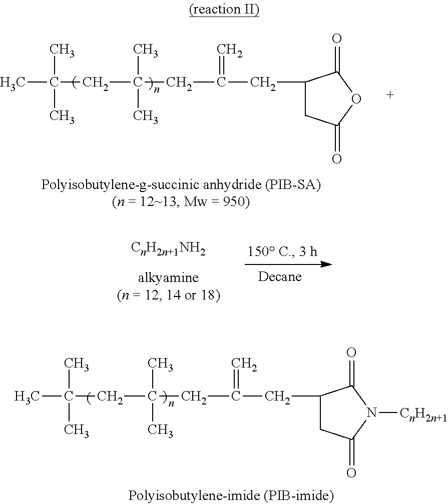

In embodiment 5, reacting PIB-SA and EDA under the ration of 2:1: the method for preparing, sampling and measuring are the similar with the above-mentioned embodiment 1. The PIB-SA (133.5 g, MW=1335) solved in decane (133.5 g) and EDA (ethylenediamine, 3 g) solved in decane (3 g) are the reactants. The reaction time is 3 hours under 25° C. The product of fully reacting is brown viscous liquid which is the dispersant of the present invention and it is abbreviated as PIB-amindoacid-PIB.

Embodiment 5 could be illustrated by the following reaction III:

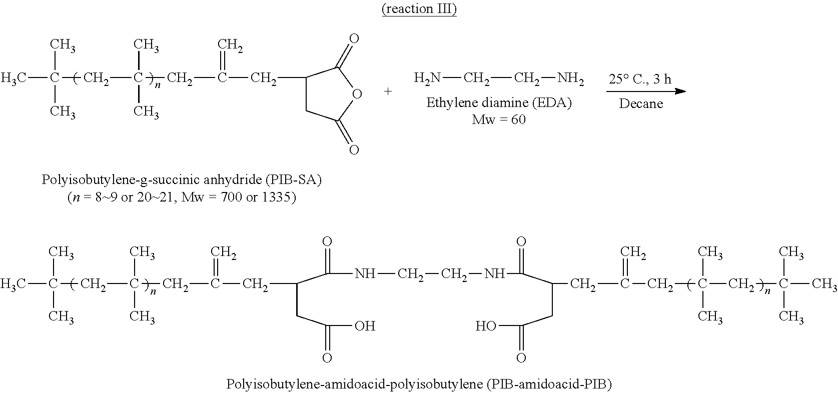

In embodiment 6, reacting PIB-SA and DETA under the ration of 2:1: the method for preparing, sampling and measuring are the similar with the above-mentioned embodiment 1. The PIB-SA (80.1 g, MW=1335) solved in decane (80.1 g) and, DETA (diethylenetriamine, 3.09 g) solved in decane (3.09 g) are the reactants. The reaction time is 3 hours under 150° C. The product of fully reacting is brown viscous liquid which is the dispersant of the present invention and it is abbreviated as PIB-imide-PIB.

Embodiment 6 could be illustrated by the following reaction IV:

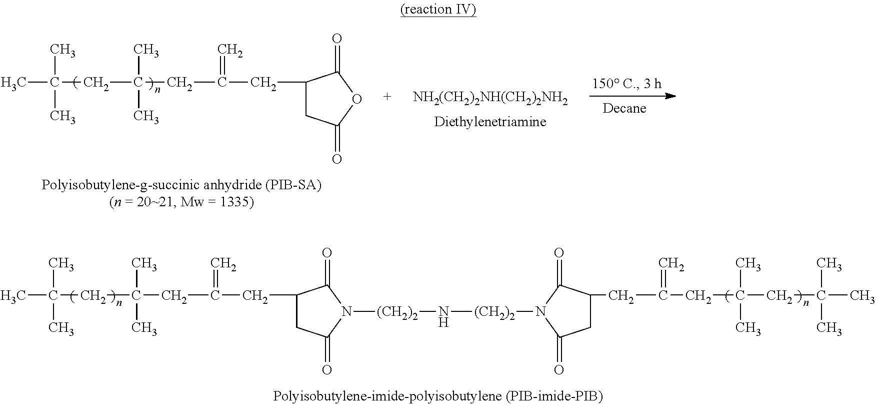

The synthesis properties of macromolecule dispersant of above-mentioned embodiments 1˜6 are compiled as Table 1.

TABLE 1
The synthesis properties of macromolecule dispersant of embodiments 1~6

| | The molar ration of PIB-SA:amine | | Abbriviation of |
|---|---|---|---|
| Embodiment | compound | | dispersant |
| 1 | PIB-SA:C₁₂H₂₅NH₂ | 1:1 | PIB-amidoacid-C12 |
| 2 | PIB-SA:C₁₄H₂₉NH₂ | 1:1 | PIB-amidoacid-C14 |
| 3 | PIB-SA:C₁₈H₃₇NH₂ | 1:1 | PIB-amidoacid-C18 |
| 4 | PIB-SA:C₁₈H₃₇NH₂ | 1:1 | PIB-imide-C18 |
| 5 | PIB-SA:EDA | 2:1 | PIB-amidoacid-PIB |
| 6 | PIB-SA:DETA | 2:1 | PIB-imide-PIB |

Embodiments 7˜9 give the examples of the method for preparing more complex macromolecule dispersant.

In embodiment 7, reacting PIB-SA and the compounds represented by following formula X

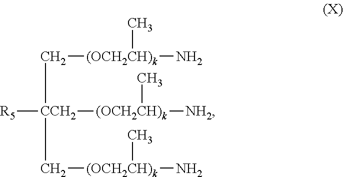

under the ration of 1:1, wherein k is an integer, 5≦k≦33 and the R₅ is one of a hydrogen atom and an ethyl group. First, solving PIB-SA (0.1 mol) by decane in a flask and stirring with magnetite. And then, adding compounds represented by formula (X) (0.1 mol) into decane in a glass bottle and shocking for desolving with a shocker. Slowly droping the mixture of compounds represented by formula (X) and decane into the mixture of PIB-SA and decane and then causing the reaction in 25° C. for 3 hours. Measuring the reaction by IR spectrometer and sampling after periods till the peak of anhydride functional group shown by FT-IR spectrum disappears, the amide groups are formed and the amide groups doesn't increase any more. The product of fully reacting is brown viscous liquid which is the dispersant of the present invention.

In embodiment 8, the product of the embodiment 7 can be further reacted with PIB-SA under the ration of 1:1 in the method similar to that of the embodiment 7. The similar procedure can be repeated to conjugate more PIB-SA to the amine groups still available for PIB-SA till all the amine groups are turned into secondary amines.

In embodiment 9, the product of the embodiment 7 can be further reacted under the condition similar to that of the embodiment 4. In this case, the amine group already conjugated with PIB-SA is no longer available for another PIB-SA. And the other two amine groups are still available for conjugating to more PIB-SAs. With the additional step, the available amine groups of current product can be reacted with extra PIB-SA in the method similar to that of the embodiment 7. The final product of the embodiment 9 has a PIB-amindoacid group and PIB-imide group.

Embodiments 10˜19 give the examples of the method for preparing nano pigment dispersant composition.

In embodiment 10, preparing nano pigment dispersant composition with the PIB-amindoacid-C12 dispersant of embodiment 1. PIB-amindoacid-C12 (1 g) and decane (18 g) are mixed in a 100 ml polyethylene (PE) bottle by shaker. The purple 23 pigment (1 g) and the Zr beads (50 g, diameter 1.5 mm) are ground in a ball mill under 50 rpm and room temperature for 48 hours to obtain the nano pigment dispersant composition.

In embodiment 11, preparing nano pigment dispersant composition with the PIB-amindoacid-C14 dispersant of embodiment 2. The method for preparing is the same as the above-mentioned embodiment 10. Decane (18 g) is used to disperse the PIB-amindoacid-C14 (1 g), the purple 23 pigment (1 g) and the Zr beads (50 g, diameter 1.5 mm) as material. The nano pigment dispersant composition is obtained under above-mentioned grinding condition.

In embodiment 12, preparing nano pigment dispersant composition with the PIB-amindoacid-C18 dispersant of embodiment 3. The method for preparing is the same as the above-mentioned embodiment 10. Decane (18 g) is used to disperse the PIB-amindoacid-C18 (1 g), the purple 23 pigment (1 g) and the Zr beads (50 g, diameter 1.5 mm) as material. The nano pigment dispersant composition is obtained under above-mentioned grinding condition.

In embodiment 13, preparing nano pigment dispersant composition with the PIB-imide-C18 dispersant of embodiment 4. The method for preparing is the same as the above-mentioned embodiment 10. Decane (18 g) is used to dispersed the PIB-imide-C18 (1 g), the purple 23 pigment (1 g) and the Zr beads (50 g, diameter 1.5 mm) as material. The nano pigment dispersant composition is obtained under above-mentioned grinding condition.

In embodiment 14, preparing nano pigment dispersant composition with the PIB-amidoacid-PIB dispersant of embodiment 5. The method for preparing is the same as the above-mentioned embodiment 10. Decane (18 g) is used to disperse the PIB-amidoacid-PIB (1 g), the purple 23 pigment (1 g) and the Zr beads (50 g, diameter 1.5 mm) as material. The nano pigment dispersant composition is obtained under above-mentioned grinding condition.

In embodiment 15, preparing nano pigment dispersant composition with the PIB-imide-PIB dispersant of embodiment 6. The method for preparing is the same as the above-mentioned embodiment 10. Decane (18 g) is used to disperse the PIB-imide-PIB (1 g), the purple 23 pigment (1 g) and the Zr beads (50 g, diameter 1.5 mm) as material. The nano pigment dispersant composition is obtained under above-mentioned grinding condition.

In embodiment 16, preparing nano pigment dispersant composition with the PIB-amidoacid-PIB dispersant of embodiment 5. The method for preparing is the same as the above-mentioned embodiment 10. Decane (18 g) is used to disperse the PIB-amidoacid-PIB (1 g), the carbon black pigment (1 g) and the Zr beads (50 g, diameter 1.5 mm) as material. The nano pigment dispersant composition is obtained under above-mentioned grinding condition.

In embodiment 17, preparing nano pigment dispersant composition with the PIB-imide-PIB dispersant of embodiment 6. The method for preparing is the same as the above-mentioned embodiment 10. Decane (18 g) is used to disperse the PIB-imide-PIB (1 g), the carbon black pigment (1 g) and the Zr beads (50 g, diameter 1.5 mm) as material. The nano pigment dispersant composition is obtained under above-mentioned grinding condition.

In embodiment 18, preparing nano pigment dispersant composition with the PIB-amidoacid-PIB dispersant of embodiment 5. The method for preparing is the same as the above-mentioned embodiment 10. Decane (18 g) is used to disperse the PIB-amidoacid-PIB (1 g), the yellow 138 pigment (1 g) and the Zr beads (50 g, diameter 1.5 mm) as material. The nano pigment dispersant composition is obtained under above-mentioned grinding condition.

In embodiment 19, preparing nano pigment dispersant composition with the PIB-imide-PIB dispersant of embodiment 6. The method for preparing is the same as the above-mentioned embodiment 10. Decane (18 g) is used to disperse the PIB-imide-PIB (1 g), the yellow 138 pigment (1 g) and the Zr beads (50 g, diameter 1.5 mm) as material. The nano pigment dispersant composition is obtained under above-mentioned grinding condition.

Comparative example 1˜2 are the method for preparing the nano pigment dispersant composition for compare.

Comparative example 1 is the control group to the embodiment 10˜19 and the method for preparing is as same as the embodiment 10. Decane (18 g) is used to disperse the PIB-SA (MW=950, 1 g), the purple 23 pigment (1 g) and the Zr beads (50 g, diameter 1.5 mm) as material. The nano pigment dispersant composition is obtained under above-mentioned grinding condition.

Comparative example 2 is also the control group to the embodiment 10˜19 and the method for preparing is as same as the embodiment 10. Decane (18 g) is used to dispersed the C₁₈H₃₇NH₂ (C18-amine, 1 g), the purple 23 pigment (1 g) and the Zr beads (50 g, diameter 1.5 mm) as material. The nano pigment dispersant composition is obtained under above-mentioned grinding condition.

Measuring the viscosity and the particle diameter of Embodiments 10˜19 and comparative example 1˜2 after the preparation thereof by the techniques to be familiar to the person having ordinary skill in the art.

TABLE 2
The influence of dispersant to nano pigment dispersant composition

| | | | particle | |
|---|---|---|---|---|
| | Dispersant | viscosity | diameter | |
| | abbriviation | (cps)^{a} | (nm)^{b} | PDI^{b} |
| Ebodiment | | | | |
| Purple 23 | | | | |
| embodiment10 | PIB-amidoacid-C12 | 7.29 | 564.1 | 0.303 |
| embodiment11 | PIB-amidoacid-C14 | 3.33 | 539.4 | 0.269 |
| embodiment12 | PIB-amidoacid-C18 | 3.03 | 363.8 | 0.235 |
| embodiment13 | PIB-amidoacid-C18 | 2.65 | 192.5 | 0.159 |
| embodiment14 | PIB-amidoacid-PIB | 2.67 | 117.7 | 0.155 |
| embodiment15 | PIB-imide-PIB | 2.31 | 91.5 | 0.144 |
| Carbon black | | | | |
| embodiment16 | PIB-amidoacid-C18 | 2.37 | 140.8 | 0.128 |
| embodiment17 | PIB-imide-C18 | 3.26 | 481.0 | 0.256 |
| Yellow 138 | | | | |
| embodiment18 | PIB-amidoacid-C18 | 3.05 | 315.9 | 0.169 |
| embodiment19 | PIB-imide-C18 | 2.99 | 264.3 | 0.129 |
| Control | | | | |
| Purple 23 | | | | |
| Comparative | PIB-SA | 10.72 | 1141.0 | 0.342 |
| example 1 | | | | |
| Comparative | C18-amine | 11.22 | 2521.7 | — |
| example 2 | | | | |

^{a}The dispersant composition is consist of the dispersant (1 g), the pigment (1 g) and decane (18 g). The viscosities (spindle S18, 100 rpm, 25° C., centipoise (cps)) are measured right after grinding.
^{b}The samples are diluted to 2 ppm and the particle dispersion indices (DPI) are measured under 25° C.

In Table 2, longer the carbon chain of the amine compound will lead to bigger the steric hindrance between dispersants and smaller the extent of the dispersants closing and attracting to each other, and thus the dispersity of the whole dispersant is better and the diameter of the pigment particles is smaller. In the aspect of viscosity, bigger the distance between each dispersant molecule, better the covering of each dispersant molecule, fewer the clotting between dispersant molecules, and thus the viscosity of the whole dispersant is smaller. Smaller the diameter of dispersant molecule, better the effect of dispersion, and thus the particle dispersion index (PDI) of the dispersant is smaller.

For pigments, the different dispersants causing different particle diameters. Thus, the diameter of the pigment particles of nano pigment dispersant is between 100˜200 nm under the observation of transmission electron microscope. That result is consistent with the analysis result of dynamic light scattering (DLS).

Besides, after mixing the nano pigment dispersant composition of present invention (oil phase, i.g. embodiment 10) with water (water phase) in a container and then standing the container, the oil phase and water phase repel each other and the emulsification does not appear. Further, the nano pigment dispersant composition (i.g. embodiment 10) is applied to the electrowetting display, when the potential is 0V, the nano pigment dispersant composition spread in each pixels evenly; when the potential raising to 20V, the nano pigment dispersant composition shrink to the corners of each pixels; when the potential decreasing back to 0V, the nano pigment dispersant composition re-spread in each pixels evenly. It shows that the nano pigment dispersant composition made of the macromolecule dispersant of the present invention demonstrates well driving effect and is applicable to the electrowetting display.

According to all above-mentioned, the macromolecule dispersant of the present invention can spread different pigment particles effectively and evenly. The provided nano pigment dispersant composition has the ink optical density bigger or equal to 1.1, the viscosity roughly smaller or equal to 4 cps. Its fluidity is good and the viscosity could be adjusted to bigger than 4 cps easily according the potential or practical conditions when being used for a coloration material.

What is claimed is:

1. A dispersant composition, comprising:
a dispersant including:
an Rₐ group represented by formula I: 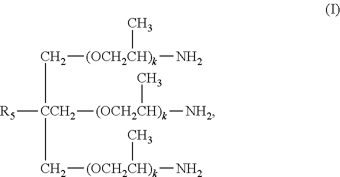
wherein k is an integer, 5≦k≦33 and R₅ is one of a hydrogen atom and an ethyl group; and
a first R_{b} group represented by formula II: 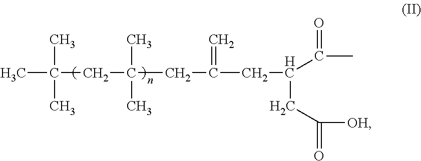 [SMILES: C=C(CC(CC(=O)O)C(C)=O)CC(C)(C)CC(C)(C)C]
wherein the first R_{b} group substitutes a hydrogen atom of the amine groups of the Rₐ group and n is equal to one being selected from the group consisting of 8, 9, 12, 13, 20 and 21.

2. The dispersant composition according to claim 1, further comprising a pigment mixed with the dispersant to form a colored dispersant composition.

3. The dispersant composition according to claim 2, wherein the pigment is one of an organic pigment and an inorganic pigment.

4. The dispersant composition according to claim 1, further comprising a second R_{b} group substituting another hydrogen atom of the other amine groups of the Rₐ group.

5. The dispersant composition according to claim 4, further comprising a third R_{b} group substituting the other one hydrogen atom of the rest amine groups of the Rₐ group.

6. A dispersant composition comprising:
a dispersant including:
an Rₐ having X groups of amine, wherein X is an integer, and 1≦X≦6; and
at least one R_{b} group being one of a first compound represented by formula II 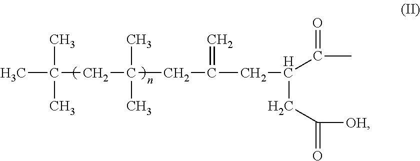 [SMILES: C=C(CC(CC(=O)O)C(C)=O)CC(C)(C)CC(C)(C)C]
and a second compound represented by formula III 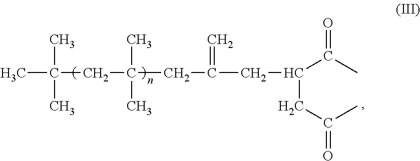 [SMILES: C=C(CC(CC(C)=O)C(C)=O)CC(C)(C)CC(C)(C)C]
wherein the first compound substitutes a hydrogen atom of one amine group of the Rₐ group, the second compound substitutes two hydrogen atoms of the same amine group of the Rₐ group, and n in each of the first and second compounds is one selected from the group consisting of 8, 9, 12, 13, 20 and 21.

7. The dispersant composition according to claim 6, wherein the Rₐ group is an alkylamine.

8. The dispersant composition according to claim 6, further comprising a pigment mixed with the dispersant to form a colored dispersant composition.

9. The dispersant composition according to claim 8, wherein the pigment is one of an organic pigment and an inorganic pigment.

10. The dispersant composition according to claim 9, wherein the organic pigment has a color being one selected from the group consisting of a red, an orange, a yellow, a green, a blue, a purple, a brown, a black, a white and a combination thereof, and the inorganic pigment has a color being one selected from the group consisting of a carbon black, a titanium dioxide and a combination thereof.

11. The dispersant composition according to claim 6, wherein the number of the at least one R_{b} group attached to the Rₐ group is one, the Rₐ group is one selected from the group consisting of a third compound represented by CₐH₂ₐ₊₁NH₂ with 6≦a≦18, a fourth compound represented by formula IV: 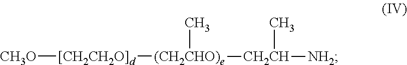
a fifth compound represented by formula V: 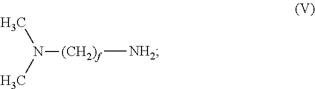
an ethanolamine represented by HO(CH₂)₂NH₂, a diethanolamine represented by HO(CH₂)₂NH(CH₂)₂OH, an aminoethylethanolamine represented by HO(CH₂)₂NH(CH₂)₂NH₂ and an ethylenediamine represented by NH₂(CH₂)₂NH₂, wherein d is 1 when e equals 9, d is 3 when e equals 19, d is 29 when e equals 6, d is 10 when e equals 31, 9≦f≦280, and a and f are integers.

12. The dispersant composition according to claim 6, wherein the number of the at least one R_{b} group attached to the Rₐ group is two, the Rₐ group is one selected from the group consisting of a sixth compound represented by NH₂(CH₂CH₂NH)_{g}CH₂CH₂NH₂ with 0≦g≦4, a seventh compound represented by NH₂(CH₂)ₕNH₂ with 2≦h≦12, an eighth compound represented by formula VI 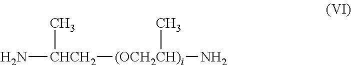
and an aminoethylethanolamine represented by HO(CH₂)₂NH(CH₂)₂NH₂, wherein 2≦i≦68, and g, h, and i are integers.

13. The dispersant composition according to claim 6, wherein the number of the at least one R_{b} group attached to the Rₐ group is three, the Rₐ group is one of a ninth compound represented by NH₂(CH₂CH₂NH)ⱼCH₂CH₂NH₂ with 1≦j≦4 and a tenth compound represented by formula I 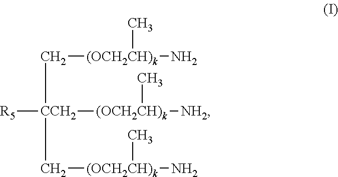
wherein k is one of 2 and 3 when R₅ is an ethyl group, 5≦k≦33 when R₅ is a hydrogen, n is one selected from the group consisting of 12, 13, 20 and 21, and j and k are integers.

14. A process for producing a dispersant composition comprising a step of causing a polyisobutylene-g-succinic anhydride to react with an alkylamine to form a dispersant, so as to obtain the dispersant composition.

15. The process according to claim 14, wherein the polyisobutylene-g-succinic anhydride and the alkylamine are dissolved in an organic solvent separately, and a reaction time of the step of causing a polyisobutylene-g-succinic anhydride to react with an alkylamine is in a range of 1 hour to 10 hours under 0° C. to 180° C.

16. The process according to claim 15, wherein the organic solvent is one selected from the group consisting of a decane, a dodecane, a toluene and an xylene.

17. The process according to claim 14, further comprising a step of adjusting the molar ratio of the polyisobutylene-g-succinic anhydride to the alkylamine, wherein the molar ratio ranges from 6:1 to 1:6.

18. The process according to claim 14, further comprising a step of mixing and grinding a pigment, a grinding media and the dispersant to form a colored dispersant composition.

19. The process according to claim 18, wherein the pigment is one of an organic pigment and an inorganic pigment.

20. The process according to claim 19, wherein the organic pigment has a color being one selected from the group consisting of a red, an orange, a yellow, a green, a blue, a purple, a brown, a black, a white and a combination thereof, and the inorganic pigment has a color being one selected from the group consisting of a carbon black, a titanium dioxide and a combination thereof.
